(19) United States
(12) Patent Application Publication
(10) Pub. No.: US 2024/0232646 A1
(43) Pub. Date: Jul. 11, 2024

(54) LEARNING APPARATUS, PREDICTION APPARATUS, LEARNING METHOD, PREDICTION METHOD AND PROGRAM

(71) Applicant: NIPPON TELEGRAPH AND TELEPHONE CORPORATION, Tokyo (JP)

(72) Inventors: Yoshiaki TAKIMOTO, Tokyo (JP); Takeshi KURASHIMA, Tokyo (JP); Yusuke TANAKA, Tokyo (JP); Tomoharu IWATA, Tokyo (JP)

(21) Appl. No.: 18/558,458

(22) PCT Filed: May 7, 2021
(86) PCT No.: PCT/JP2021/017568

§ 371 Date: Nov. 1, 2023

(51) Int. Cl. G06N 3/098

(52) U.S. Cl. CPC G06N 3/098

(57) ABSTRACT

A learning device for predicting an occurrence of an event includes a memory and a processor configured to divide a support set extracted from a set of previous data for learning into a plurality of sections, output a first latent vector based on each of the plurality of divided sections and output a second latent vector based on each of the output first latent vectors, and output an intensity function indicating a likelihood of the event occurring based on the second latent vector.

### TECHNICAL FIELD

The present invention relates to a learning device, a predicting device, a learning method, a predicting method, and a program.

### BACKGROUND ART

Techniques for predicting events such as equipment failures, human behavior, crimes, earthquakes, and infectious diseases using point processes are being researched. It is known that prediction by a point process is performed by learning using previous data of a sequence to be predicted and calculating an intensity function which indicates the likelihood of events occurring in a time period in future.

In addition, methods using meta-learning are being studied to save the trouble of learning for each sequence. For example, NPL 1 discloses a meta-learning technique based on model-agnostic meta-learning (MAML).

### CITATION LIST

### Non-Patent Literature

NPL 1: Yujia Xie, Haoming Jiang, Feng Liu, Tuo Zhao, and Hongyuan Zha, “Meta Learning with Relational Information for Short Sequences”, 33rd Conference on Neural Information Processing Systems (NeurIPS 2019), Vancouver, Canada

### SUMMARY OF INVENTION

### Technical Problem

The technique in the related art has a problem that it is difficult to appropriately ascertain a relationship of previous events with a small amount of calculation in meta-learning for prediction by a point process.

An object of the disclosed technique is to appropriately ascertain a relationship of previous events with a small amount of calculation in meta-learning for prediction by a point process.

### Solution to Problem

The disclosed technique is a learning device for predicting an occurrence of an event which includes: a dividing unit which divides a support set extracted from a set of previous data for learning into a plurality of sections; a latent expression extracting unit which outputs a first latent vector based on each of the plurality of divided sections and outputs a second latent vector based on each of the output first latent vectors; and an intensity function derivation unit which outputs an intensity function indicating a likelihood of an event occurring based on the second latent vector.

### Advantageous Effects of Invention

In meta-learning for prediction by a point process, a relationship of previous events can be ascertained appropriately with a small amount of calculation.

### BRIEF DESCRIPTION OF DRAWINGS

FIG. 1 is a functional configuration diagram of a learning device.

FIG. 2 is a flowchart for describing an example of a flow of learning processing.

FIG. 3 is a functional configuration diagram of a predicting device.

FIG. 4 is a flowchart for describing an example of a flow of prediction processing.

FIG. 5 is a diagram for explaining processing in the related art.

FIG. 6 is a diagram for explaining processing according to the present embodiment.

FIG. 7 is a diagram illustrating a hardware configuration example of a computer.

### DESCRIPTION OF EMBODIMENTS

An embodiment of the present invention (present embodiment) will be described below with reference to the drawings. The embodiment described below is merely an example and embodiments to which the present invention is applied are not limited to the following embodiment.

A learning device 1 according to the present embodiment is a device which performs meta-learning for predicting an occurrence of an event by a point process. Event

t∈ [symbol] ¹ [Math. 1]

represents a time at which an event occurred and an observation start of the sequence is set to 0.

### Sequence Data

E=({tᵢ}ᵢ₌₁^{I},t^{e}) [Math. 2]

is a sequence of I events. Here, t^{e} is an observation end time. The number of events may differ depending on the sequence.

### Training Data Set During Training

D={E^{j}}ⱼ₌₁^{J}[Math. 3]

is J items of sequence data. For prediction, the observation time is Tₛ*=[0, tₛ*], the prediction period is T_{q}*=(tₛ*, t_{q}*] and the prediction target sequence is E*. At this time, any event tᵢ included in E* satisfies 0≤tᵢ≤tₛ*. The goal of prediction is to obtain an intensity function λ(t) (tₛ*<t≤t_{q}*) that indicates the likelihood of an event occurring during the prediction period T_{q}* of the prediction target sequence E*.

### (Functional Configuration of Learning Device)

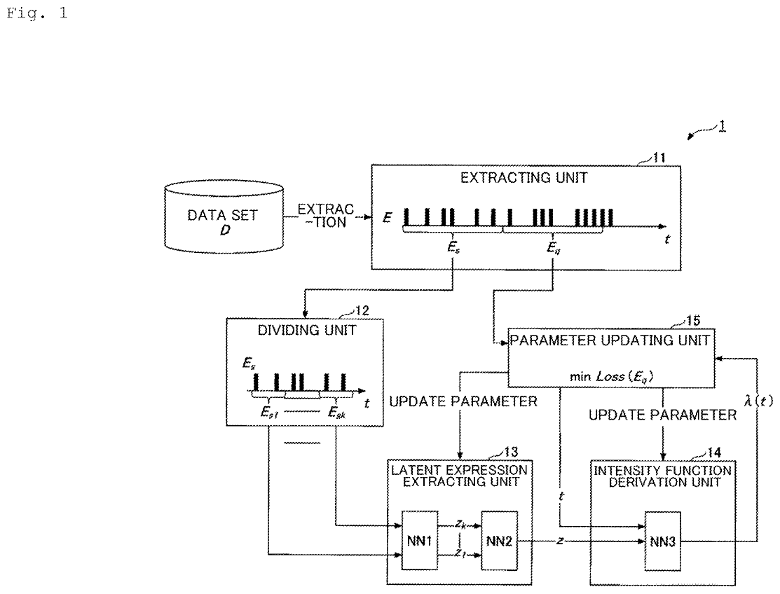

FIG. 1 is a functional configuration diagram of a learning device. A learning device 1 includes an extracting unit 11, a dividing unit 12, a latent expression extracting unit 13, an intensity function derivation unit 14, and a parameter updating unit 15.

The extracting unit 11 randomly selects a sequence E^{j} (hereinafter also referred to as E by omitting j) from a data set D, which is a set of previous data for learning.

Subsequently, the extracting unit 11 determines tₛ, t_{q} (0<tₛ<t_{q}≤tₑ). A determination method may be random or may use tₛ* and t_{q}* when performing assumed prediction. Also, the extracting unit 11 extracts, from the sequence E, a support set Eₛ={tᵢ|0≤tᵢ≤tₛ} and a query set E_{q}>={tᵢ|tₛ<tᵢ≤t_{q}}. Note that the extracting unit 11 may extract the query set E_{q} from {tᵢ|0≤tᵢ≤t_{q}}.

The dividing unit 12 divides the support set Eₛ into a plurality of sections based on defined rules. Examples of dividing methods include specified time intervals (for example, [0,tₛ/3), [tₛ/3,2tₛ/3), [2tₛ/3,tₛ]), and equalizing the expected value of the number of events included in each section expressed as follows:

[symbol]

_{j,k}[|Eₛₖ^{j}|] [Math. 4]

Hereinafter, the dividing unit 12 divides the support set Eₛ into K sections and the sequence of events included in a kth section is defined as Eₛₖ.

The latent expression extracting unit 13 inputs each of the divided support sets

{Eₛₖ}ₖ₌₁^{K} [Math. 5]

to an NN1 corresponding to each of the sections to obtain the latent vector

{zₖ}ₖ₌₁^{K} [Math. 6]

(first latent vector). NN1 is a model (first model) that can handle variable-length inputs, such as Deepset, Transformer, or RNN.

The latent expression extracting unit 13 also inputs a latent vector zₖ of each section output from each NN1 to NN2 to obtain a latent vector z (second latent vector). NN2 (second model) can be any neural network if K is constant, and a neural network that can handle variable-length inputs if K is variable.

The intensity function derivation unit 14 inputs a latent vector z and a time t to NN3 to obtain an intensity function λ(t). NN3 (third model) is a neural network in which any output is a positive scalar value.

The parameter updating unit 15 calculates a negative logarithmic likelihood from the intensity function λ(t) and E_{q}, and uses an error backpropagation method or the like to update parameters of the models (NN1, NN2 and NN3) of the latent expression extracting unit 13 or the intensity function derivation unit 14.

### (Operations of Learning Device)

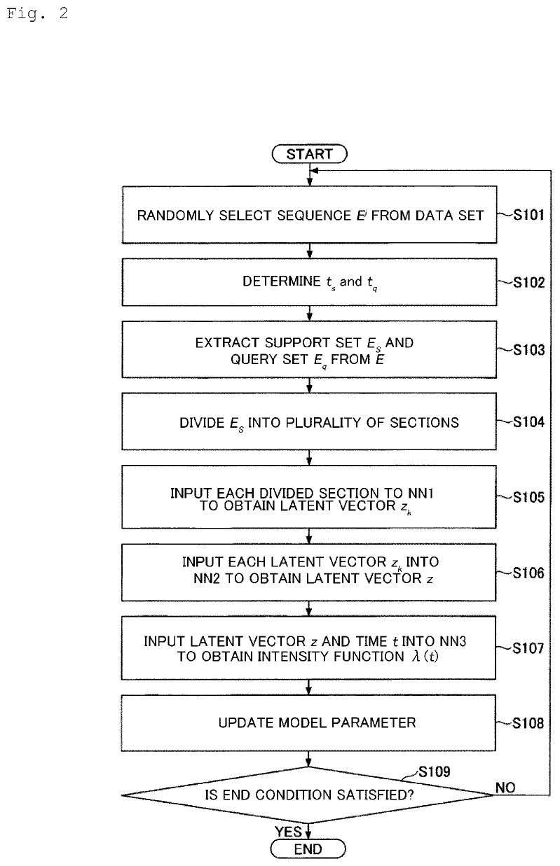

FIG. 2 is a flowchart for describing an example of a flow of learning processing.

The learning device 1 performs learning processing according to a user's operation or a predefined schedule. The extracting unit 11 randomly selects a sequence E^{j} from the data set D (Step S101). Also, the extracting unit 11 determines tₛ, t_{q}(0<tₛ<t_{q}≤tₑ) (Step S102). Subsequently, the extracting unit 11 extracts the support set Eₛ and the query set E_{q} from the sequence E (Step S103).

The dividing unit 12 divides the support set Eₛ into a plurality of (K) sections (Step S104). The latent expression extracting unit 13 inputs each divided section Eₛₖ to NN1 corresponding to each of the sections to obtain a latent vector zₖ (Step S105). Furthermore, the latent expression extracting unit 13 inputs each latent vector zₖ to NN2 to obtain a latent vector z (Step S106).

Subsequently, the intensity function derivation unit 14 inputs the latent vector z and the time t to NN3 to obtain the intensity function λ(t) (Step S107). The parameter updating unit 15 updates the parameters of each model (Step S108).

The learning device 1 determines whether an end condition is satisfied as a result of updating the parameters (Step S109). The end condition is, for example, a condition in which a difference between values before and after updating is less than a predetermined threshold or a condition that the number of updates reaches a predetermined number.

When determining that the end condition is not satisfied (Step S109: No), the learning device 1 returns to Step S101. Alternatively, when determining that the end condition is satisfied (Step S109: Yes), the learning device 1 ends the learning process.

Also, a predicting device 2 according to the present embodiment is a device configured to predict an occurrence of an event by a point process using models of NN1, NN2, and NN3 whose parameters have been updated by the learning device 1.

### (Functional Configuration of Predicting Device)

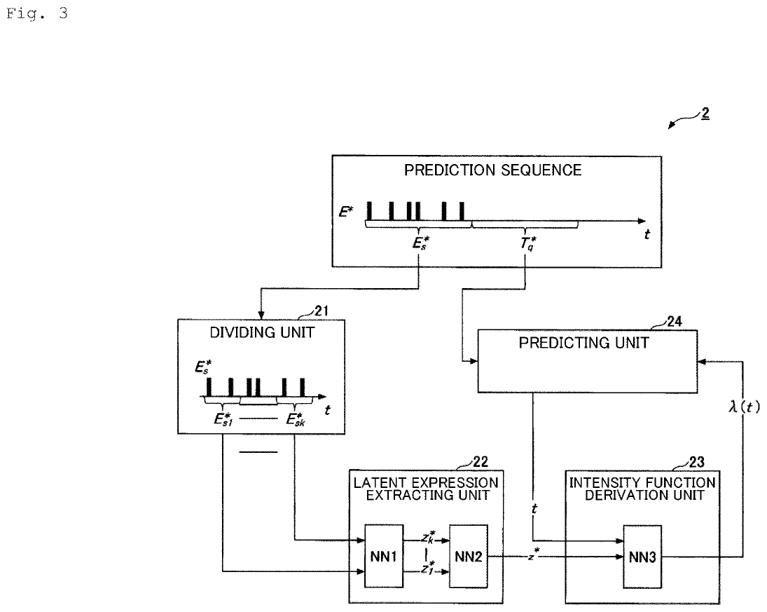

FIG. 3 is a functional configuration diagram of the predicting device. The predicting device 2 includes a dividing unit 21, a latent expression extracting unit 22, an intensity function derivation unit 23, and a predicting unit 24.

The dividing unit 21 regards the prediction sequence E* as Eₛ* and divides Eₛ* into a plurality of sections Eₛₖ* as in the dividing unit 12 of the learning device 1.

As in the latent expression extracting unit 13 of the learning device 1, the latent expression extracting unit 22 inputs each of the divided support sets to NN1 (first model) corresponding to each of the sections to obtain the latent vector zₖ* (first latent vector). Also, the latent expression extracting unit 22 inputs the latent vector zₖ* of each section output from each NN1 to NN2 (second model) to obtain a latent vector z* (second latent vector).

As in the intensity function derivation unit 14 of the learning device 1, the intensity function derivation unit 23 inputs the latent vector z* and a time t to NN3 (third model) to obtain the intensity function λ(t).

The predicting unit 24 predicts a situation of occurrences of events during the prediction period T_{q}* using the intensity function λ(t).

The predicting device 2 may generate an event by simulation and output a prediction result (Y. Ogata, “On Lewis' simulation method for point processes”, IEEE Transactions on Information Theory, Volume 27, Issue 1, January 1981, pp. 23 to 31).

### (Operations of Predicting Device)

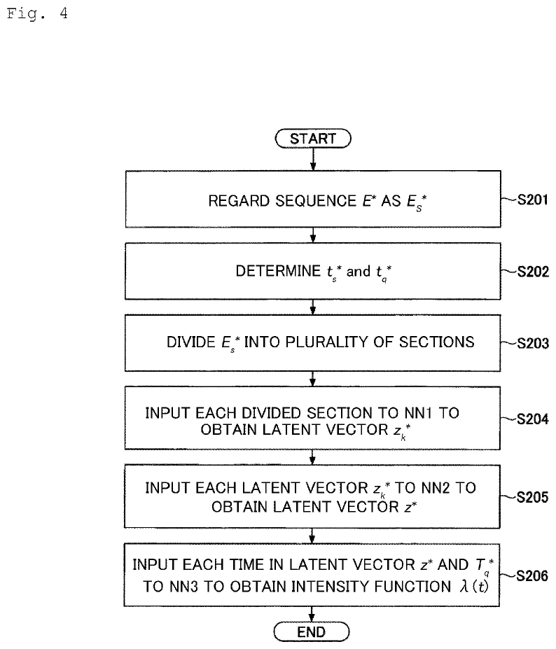

FIG. 4 is a flowchart for describing an example of a flow of prediction processing. The predicting device 2 performs the prediction processing according to a user's operation or the like.

The dividing unit 21 of the predicting device 2 regards the prediction sequence E* as Eₛ* (Step S201). Also, the dividing unit 21 determines tₛ* and t_{q}* (Step S202). Subsequently, the dividing unit 21 divides the support set Eₛ* into a plurality of sections (Step S203).

The latent expression extracting unit 22 inputs each divided section Eₛₖ* to NN1 to obtain a latent vector zₖ* (Step S204). Furthermore, the latent expression extracting unit 22 inputs each latent vector zₖ* to NN2 to obtain a latent vector z* (Step S205).

Subsequently, the intensity function derivation unit 23 inputs the latent vector z* and each time t within the prediction period T_{q}* to NN3 to obtain the intensity function λ(t) (Step S206).

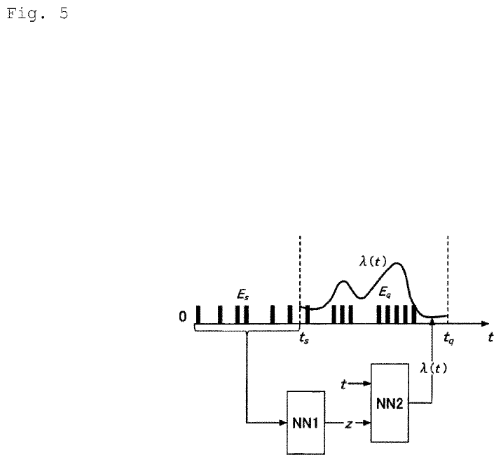

FIG. 5 is a diagram for explaining processing in the related art. A device in the related art has a configuration in which the entire support set Eₛ is input to NN1 at once to output the latent vector z, and input z and t to NN2 to obtain the intensity function λ(t).

In this case, when NN1 is, for example, a Deepset, there is a problem that a relationship of previous events cannot be ascertained. Furthermore, when NN1 is a Transformer, there is a problem that the amount of calculation is proportional to the square of the previous events and the amount of calculation becomes enormous. In addition, when NN1 is an RNN, although a relationship of adjacent events can be ascertained, there is a problem that it is difficult to ascertain a relationship of distant events. Furthermore, when NN1 is a Transformer or RNN, it is assumed that the input is time-sequence data at regular intervals. Thus, there is a problem that it is difficult to ascertain characteristics of the sparseness or density of previous data and input for each occurrence of an event, that are required to be ascertained.

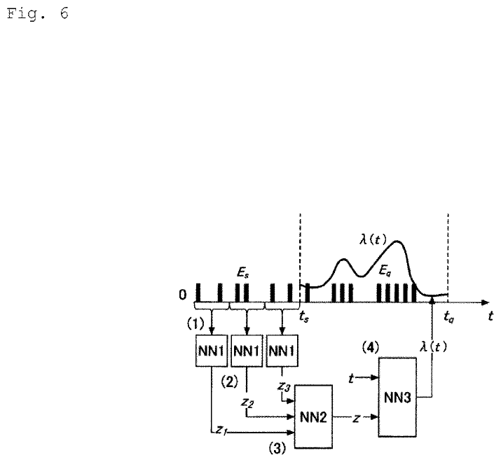

FIG. 6 is a diagram for explaining the processing of the present embodiment. The learning device 1 or the predicting device 2 in the present embodiment (1) divides the support set E: into a plurality of (K) sections, inputs each divided section into a different NN1 to obtain a latent vector zₖ. Furthermore, the learning device 1 or the predicting device 2 (3) inputs each latent vector zₖ to NN2 to obtain a latent vector z. Subsequently, the learning device 1 or the predicting device 2 (4) inputs the latent vector z and the time t to NN3 to obtain an intensity function λ(t).

According to the learning device 1 or the predicting device 2 relating to the present embodiment, an average sequence length to be calculated in NN1 is 1/K compared to the method in the related art in FIG. 5. Thus, the amount of calculation can be reduced. For example, when NN1 is a Transformer, the amount of calculation is proportional to the square of the sequence length, and when NN1 is an RNN, the amount of calculation is proportional to the sequence length.

Furthermore, the learning device 1 or the predicting device 2 can perform parallel distributed processing for each section. In this respect, for example, when NN1 is an RNN, it is necessary to perform sequential processing in the method in the related art.

Furthermore, the learning device 1 or the predicting device 2 can ascertain a sequential relationship of events according to which sections the respective events are included. In this respect, when NN1 is, for example, a Deepset, there is a problem that a relationship of previous events cannot be ascertained.

Furthermore, the learning device 1 or the predicting device 2 can directly ascertain whether occurrence intervals of events are sparse or dense for each section.

Marks or additional information may be added to the event data. For example, let the event data be (t,m). m is a mark or additional information. In this case, the learning device 1 or the predicting device 2 may perform learning processing and prediction processing using a neural network NN4 suitable for marks or additional information before NN1, as follows:

NN1({[tᵢNN4(mᵢ)]}₍ₜ_{ᵢ}_{,m}_{ᵢ}_{)∈E}_{ₛₖ}) [Math. 7]

Here, [ ] is a symbol indicating concatenation.

Furthermore, additional information ‘a’ may be added to the sequence. In this case, the learning device 1 or the predicting device 2 may perform learning processing or prediction processing using neural networks (NN5, NN6) suitable for additional information before NN3. That is to say, the learning device 1 or the predicting device 2 inputs the latent vector z′ obtained by the following expression to NN3.

z′=NN6([z,NN5(a)])

Also, although the dimensionality of the event is one in the present embodiment, it may be extended to any dimensionality (for example, three dimensions in time and space).

### (Hardware Configuration Example According to Present Embodiment)

The learning device 1 and the predicting device 2 can be implemented, for example, by causing a computer to execute a program describing the processing details described in the present embodiment. Note that the “computer” may be a physical machine or a virtual machine in the cloud. When using a virtual machine, the “hardware” described herein is virtual hardware.

The above program can be recorded in a computer-readable recording medium (portable memory or the like), saved, or distributed. It is also possible to provide the above program through a network such as the Internet or e-mail.

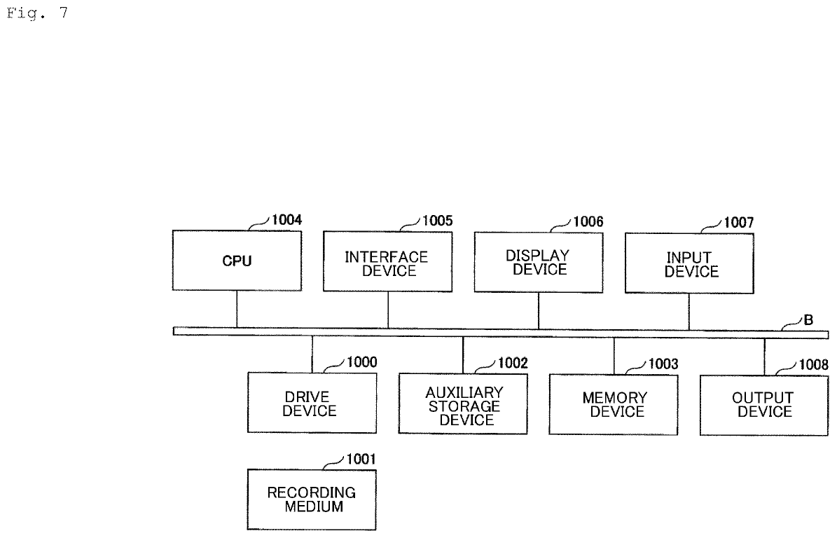

FIG. 7 is a diagram illustrating a hardware configuration example of the computer. The computer of FIG. 7 has a drive device 1000, an auxiliary storage device 1002, a memory device 1003, a CPU 1004, an interface device 1005, a display device 1006, an input device 1007, an output device 1008, and the like which are connected to each other via a bus B, respectively.

A program for realizing processing by the computer is provided by, for example, a recording medium 1001 such as a CD-ROM or a memory card. When a recording medium 1001 storing a program is set in the drive device 1000, the program is installed from the recording medium 1001 to the auxiliary storage device 1002 via the drive device 1000. Here, the program need not necessarily be installed from the recording medium 1001 and may be downloaded from another computer via the network. The auxiliary storage device 1002 stores installed programs as well as necessary files and data.

The memory device 1003 reads the program from the auxiliary storage device 1002 and stores it when a program activation instruction is received. The CPU 1004 implements functions relating to the device according to programs stored in the memory device 1003. The interface device 1005 is used as an interface for connecting to a network. The display device 1006 displays a graphical user interface (GUI) or the like by a program. The input device 1007 is composed of a keyboard, a mouse, buttons, a touch panel, or the like and is used for inputting various operational instructions. The output device 1008 outputs the calculation result. Note that the computer may include a graphics processing unit (GPU) or a tensor processing unit (TPU) instead of the CPU 1004 or may include a GPU or TPU in addition to the CPU 1004. In that case, the processing may be divided and executed such that the GPU or the TPU executes processing which requires special computation, such as a neural network, and the CPU 1004 executes other processing.

### Examples

As an example of the present embodiment, for example, it is possible to predict an occurrence of a user's future purchasing behavior on an electronic commerce (EC) site as an event. In this case, the sequence is user information and the mark or additional information which can be added to the event may be product information, payment method, or the like relating to the purchasing behavior of each user. Furthermore, the sequence additional information may be attributes such as the user's gender and age.

In this case, as Example 1, the learning data may be an existing user event sequence of an EC site and the prediction data may be a new user's sequence for one week. Also, as Example 2, the learning data may be an event sequence of each user at various EC sites and the prediction data may be an event sequence of users at another EC site.

The examples described above are merely examples and the learning device 1 and the predicting device 2 according to the present embodiment can be used to predict occurrences of various events.

### Summary of Embodiment

This specification describes at least a learning device, a predicting device, a learning method, a predicting method, and a program described in each of the following items.

### (Item 1)

A learning device for predicting an occurrence of an event, including:
a dividing unit which divides a support set extracted from a set of previous data for learning into a plurality of sections;
a latent expression extracting unit which outputs a first latent vector based on each of the plurality of divided sections and outputs a second latent vector based on each of the output first latent vectors; and
an intensity function derivation unit which outputs an intensity function indicating a likelihood of an event occurring based on the second latent vector.

### (Item 2)

The learning device according to Item 1, further including:
a parameter updating unit which updates any parameter of a first model for outputting the first latent vector, a second model for outputting the second latent vector, and a third model for outputting the intensity function based on the intensity function.

### (Item 3)

The learning device according to Item 1 or 2, wherein the latent expression extracting unit outputs the first latent vector based on each of the plurality of divided sections by parallel distributed processing.

### (Item 4)

A predicting device for predicting an occurrence of an event, including:
a dividing unit which divides a prediction target sequence into a plurality of sections by regarding the prediction target sequence as a support set;
a latent expression extracting unit which outputs a first latent vector based on each of the plurality of divided sections and outputs a second latent vector based on each of the output first latent vectors; and
an intensity function derivation unit which outputs an intensity function indicating a likelihood of an event occurring based on the second latent vector.

### (Item 5)

The predicting device according to Item 4, further comprising:
a predicting unit which predicts a situation of occurrences of events of an event in a prediction period using the intensity function.

### (Item 6)

A learning method performed by a learning device including:
a step of dividing a support set extracted from a set of previous data for learning into a plurality of sections;
a step of outputting a first latent vector based on each of the plurality of divided sections and outputting a second latent vector based on each of the output first latent vectors; and
a step of outputting an intensity function which indicates a likelihood of an event occurring based on the second latent vector.

### (Item 7)

A predicting method performed by a predicting device including:
a step of dividing a prediction target sequence into a plurality of sections by regarding the prediction target sequence as a support set;
a step of outputting a first latent vector based on each of the plurality of divided sections and outputting a second latent vector based on each of the output first latent vectors; and
a step of outputting an intensity function which indicates a likelihood of an event occurring based on the second latent vector.

### (Item 8)

A program causing a computer to function as each unit in the learning device according to any one of Items 1 to 3 or a program causing a computer to function as each unit in the predicting device according to Item 4 or 5.

Although the present embodiment has been described above, the present invention is not limited to such a specific embodiment and various modifications and changes are possible within the scope of the gist of the present invention described in the claims.

### REFERENCE SIGNS LIST

1 Learning device
2 Predicting device
11 Extracting unit
12 Dividing unit
13 Latent expression extracting unit
14 Intensity function derivation unit
15 Parameter updating unit
21 Dividing unit
22 Latent expression extracting unit
23 Intensity function derivation unit
24 Predicting unit
1000 Drive device
1001 Recording medium
1002 Auxiliary storage device
1003 Memory device
1004 CPU
1005 Interface device
1006 Display device
1007 Input device
1008 Output device

1. A learning device for predicting an occurrence of an event, comprising:
a memory; and
a processor configured to:
divide a support set extracted from a set of previous data for learning into a plurality of sections;
output a first latent vector based on each of the plurality of divided sections and output a second latent vector based on each of the output first latent vectors; and
output an intensity function indicating a likelihood of the event occurring based on the second latent vector.

2. The learning device according to claim 1, the processor is further configured to:
update any parameter of a first model for outputting the first latent vector, a second model for outputting the second latent vector, and a third model for outputting the intensity function based on the intensity function.

3. The learning device according to claim 1, wherein the processor outputs the first latent vector based on each of the plurality of divided sections by parallel distributed processing.

4. A predicting device for predicting an occurrence of an event, comprising:
a memory; and
a processor configured to:
divide a prediction target sequence into a plurality of sections by regarding the prediction target sequence as a support set;
output a first latent vector based on each of the plurality of divided sections and output a second latent vector based on each of the output first latent vectors; and
output an intensity function indicating a likelihood of the event occurring based on the second latent vector.

5. The predicting device according to claim 4, the processor is further configured to:
predict a situation of occurrences of events of an event in a prediction period using the intensity function.

6. A learning method performed by a learning device including a memory and a processor, the method comprising:
dividing a support set extracted from a set of previous data for learning into a plurality of sections;
outputting a first latent vector based on each of the plurality of divided sections and outputting a second latent vector based on each of the output first latent vectors; and
outputting an intensity function which indicates a likelihood of an event occurring based on the second latent vector.

7. (canceled)

8. A non-transitory computer-readable recording medium having computer-readable instructions stored thereon, which, when executed, cause a computer including a memory and processor to function as the learning device according to claim 1.

9. A non-transitory computer-readable recording medium having computer-readable instructions stored thereon, which, when executed, cause a computer including a memory and processor to function as the predicting device according to claim 4.
